(19) United States
(12) Patent Application Publication
(10) Pub. No.: US 2025/0036494 A1
(43) Pub. Date: Jan. 30, 2025

(54) COMMUNICATIONS FRAMEWORK FOR PROCESS OPERATIONS ENVIRONMENT

(71) Applicant: Schlumberger Technology Corporation, Sugar Land, TX (US)

(72) Inventors: Kunal Kumar, Dubai (AE); Sneha Poddar, Houston, TX (US); Marcus Ungaretti Rossi, Houston, TX (US); Richard Booth, Calgary (CA); Varsha Gangu, Richmond, TX (US)

(21) Appl. No.: 18/697,035

(22) PCT Filed: Nov. 28, 2022
(86) PCT No.: PCT/US2022/051043

§ 371 Date: Mar. 29, 2024

Related U.S. Application Data
(60) Provisional application No. 63/283,385, filed on Nov. 26, 2021.

(51) Int. Cl. G06F 9/54

(52) U.S. Cl. CPC G06F 9/542

(57) ABSTRACT

A communications framework can include a discussion tool operable within a process operations environment, where the discussion tool issues a request for communication with an expert and records contextual information of the process operations environment: a notification tool that, responsive to issuance of the request for communication, calls for issuance of a notification to an identified expert; and a recordation tool that calls for storage of communication information associated with communication with the identified expert to a database.

### RELATED APPLICATION

This application claims priority to and the benefit of a US provisional application having Ser. No. 63/283,385, filed 26 Nov. 2021, which is incorporated by reference herein.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

In oil and gas exploration, interpretation is a process that involves analysis of data to identify and locate various subsurface structures (e.g., horizons, faults, geobodies, etc.) in a geologic environment. Various types of structures (e.g., stratigraphic formations) may be indicative of hydrocarbon traps or flow channels, as may be associated with one or more reservoirs (e.g., fluid reservoirs). In the field of resource extraction, enhancements to interpretation can allow for construction of a more accurate model of a subsurface region, which, in turn, may improve characterization of the subsurface region for purposes of resource extraction. Characterization of one or more subsurface regions in a geologic environment can guide, for example, performance of one or more operations (e.g., field operations, etc.). As an example, a more accurate model of a subsurface region may make a drilling operation more accurate as to a borehole's trajectory where the borehole is to have a trajectory that penetrates a reservoir, etc., where fluid may be produced via the borehole (e.g., as a completed well, etc.). As an example, one or more workflows may be performed using one or more computational frameworks and/or one or more pieces of equipment that include features for one or more of analysis, acquisition, model building, control, etc., for exploration, interpretation, drilling, fracturing, production, etc.

### SUMMARY

A communications framework can include a discussion tool operable within a process operations environment, where the discussion tool issues a request for communication with an expert and records contextual information of the process operations environment; a notification tool that, responsive to issuance of the request for communication, calls for issuance of a notification to an identified expert; and a recordation tool that calls for storage of communication information associated with communication with the identified expert to a database. A method can include, within an application of a process operations environment, actuating a discussion tool that issues a request for communication with an expert and records contextual information of the application; responsive to issuance of the request for communication, calling for issuance of a notification to an identified expert; and calling for storage of communication information associated with communication with the identified expert to a database. One or more computer-readable media can include computer-executable instructions executable by a system to instruct the system to: within an application of a process operations environment, actuate a discussion tool that issues a request for communication with an expert and records contextual information of the application; responsive to issuance of the request for communication, call for issuance of a notification to an identified expert; and call for storage of communication information associated with communication with the identified expert to a database. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of systems;

FIG. 3 illustrates an example of a system;

FIG. 4 illustrates an example of a system;

FIG. 5 illustrates an example of a system;

FIG. 6 illustrates an example of a system;

FIG. 7 illustrates an example of a system;

FIG. 8 illustrates examples of graphical user interfaces;

FIG. 9 illustrates examples of graphical user interfaces;

FIG. 10 illustrates examples of graphical user interfaces;

FIG. 11 illustrates examples of graphical user interfaces;

FIG. 12 illustrates examples of graphical user interfaces;

FIG. 13 illustrates an example of a communications framework and an example of a process operations framework;

FIG. 14 illustrates an example of a method and an example of a system;

FIG. 15 illustrates examples of computer and network equipment; and

FIG. 16 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

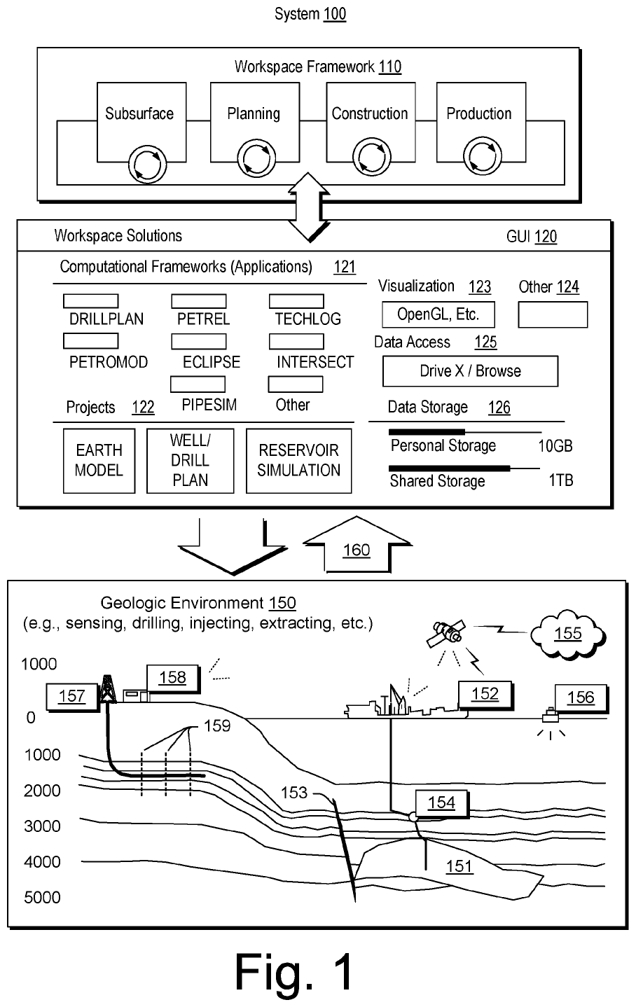

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126. As an example, the system 100 can provide for instantiation of one or more computational frameworks for a process operations environment that includes equipment at one or more sites that can perform process operations.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, PIPESIM, and INTERSECT frameworks (Schlumberger Limited, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive E&P environment (Schlumberger Limited, Houston, Texas) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI environment on demand reservoir simulation features.

The aforementioned DELFI environment provides various features for workflows as to subsurface analysis, planning, construction and production, for example, as illustrated in the workspace framework 110. Such an environment may be referred to as a process operations environment that can include a variety of frameworks (e.g., applications, etc.). As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such an approach can provide for compatibility of devices, frameworks, etc., with respect to one or more sets of instructions.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations and to determine locations of various subsurface features. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

A simulator can be utilized to simulate the exploitation of a real reservoir, for example, to examine different productions scenarios to find an optimal one before production or further production occurs. A reservoir simulator will not provide an exact replica of flow in and production from a reservoir at least in part because the description of the reservoir and the boundary conditions for the equations for flow in a porous rock are generally known with an amount of uncertainty. Certain types of physical phenomena occur at a spatial scale that can be relatively small compared to size of a field. A balance can be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results are to some extent uncertain. A process known as history matching can involve comparing simulation results to actual field data acquired during production of fluid from a field. Information gleaned from history matching, can provide for adjustments to a model, data, etc., which can help to increase accuracy of simulation.

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.).

While several simulators are illustrated in the example of FIG. 1, one or more other simulators may be utilized, additionally or alternatively. For example, consider the VISAGE geomechanics simulator (Schlumberger Limited, Houston Texas). The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The aforementioned PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (Schlumberger Limited, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena. The MANGROVE simulator (Schlumberger Limited, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

The aforementioned PETREL framework provides components that allow for optimization of exploration and development operations. The PETREL framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes (e.g., with respect to one or more geologic environments, etc.). Such a framework may be considered an application (e.g., executable using one or more devices) and may be considered a data-driven application (e.g., where data is input for purposes of modeling, simulating, etc.).

As mentioned, a framework may be implemented within or in a manner operatively coupled to the DELFI cognitive E&P environment (Schlumberger, Houston, Texas), which is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, etc.).

As to various types of data that can be processed by one or more frameworks, consider geochemical data, which can include data acquired using X-ray fluorescence (XRF) technology, Fourier transform infrared spectroscopy (FTIR) technology and/or wireline geochemical technology. As an example, one or more probes may be deployed in a bore via a wireline or wirelines. As an example, a probe may emit energy and receive energy where such energy may be analyzed to help determine mineral composition of rock surrounding a bore. As an example, nuclear magnetic resonance may be implemented (e.g., via a wireline, downhole NMR probe, etc.), for example, to acquire data as to nuclear magnetic properties of elements in a formation (e.g., hydrogen, carbon, phosphorous, etc.). As an example, lithology scanning technology may be employed to acquire and analyze data. For example, consider the LITHO SCANNER technology marketed by Schlumberger Limited (Houston, Texas). As an example, a LITHO SCANNER tool may be a gamma ray spectroscopy tool.

As an example, a tool may be positioned to acquire information in a portion of a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the aforementioned TECHLOG framework.

As an example, a workflow may utilize one or more types of data for one or more processes (e.g., stratigraphic modeling, basin modeling, completion designs, drilling, production, injection, etc.). As an example, one or more tools may provide data that can be used in a workflow or workflows that may implement one or more frameworks (e.g., PETREL, TECHLOG, PETROMOD, ECLIPSE, etc.). As explained, a framework or frameworks may be operable in a computational environment, which may be a distributed environment (e.g., cloud-based, etc.). As an example, a computational environment such as the DELFI environment can provide for coordination between projects and individuals where workflows can depend on one or more types of data and utilize one or more frameworks.

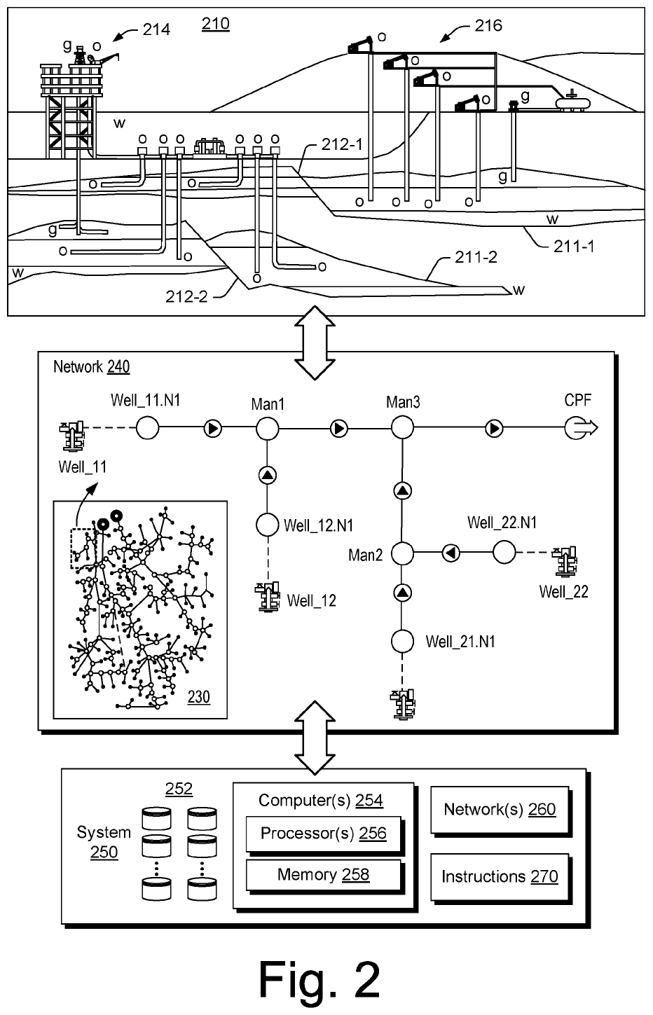

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1.

In the example of FIG. 2, the various equipment 214 and 216 can include drilling equipment, wireline equipment, production equipment, etc. For example, consider the equipment 214 as including a drilling rig that can drill into a formation to reach a reservoir target where a well can be completed for production of hydrocarbons. In such an example, one or more features of the system 100 of FIG. 1 may be utilized. For example, consider utilizing a drilling or well plan framework, a drilling execution framework, etc., to plan, execute, etc., one or more drilling operations.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of oil and gas fluids from well locations along flowlines interconnected at junctions with final delivery at a central processing facility.

In the example of FIG. 2, various portions of the network 240 may include conduit. For example, consider a perspective view of a geologic environment that includes two conduits which may be a conduit to Man1 and a conduit to Man3 in the network 240.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as subsurface imagery and/or surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.). As an example, one or more methods, techniques, etc. may be performed using one or more sets of instructions, which may be, for example, the instructions 270 of FIG. 2.

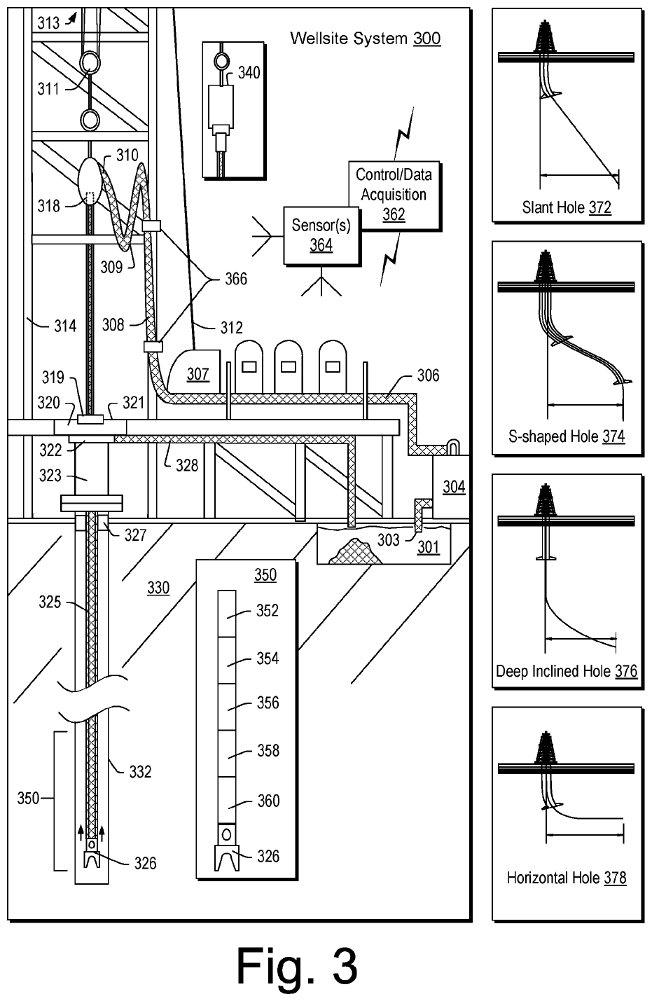

FIG. 3 shows an example of a wellsite system 300 (e.g., at a wellsite that may be onshore or offshore). As shown, the wellsite system 300 can include a mud tank 301 for holding mud and other material (e.g., where mud can be a drilling fluid), a suction line 303 that serves as an inlet to a mud pump 304 for pumping mud from the mud tank 301 such that mud flows to a vibrating hose 306, a drawworks 307 for winching drill line or drill lines 312, a standpipe 308 that receives mud from the vibrating hose 306, a kelly hose 309 that receives mud from the standpipe 308, a gooseneck or goosenecks 310, a traveling block 311, a crown block 313 for carrying the traveling block 311 via the drill line or drill lines 312, a derrick 314, a kelly 318 or a top drive 340, a kelly drive bushing 319, a rotary table 320, a drill floor 321, a bell nipple 322, one or more blowout preventors (BOPs) 323, a drillstring 325, a drill bit 326, a casing head 327 and a flow pipe 328 that carries mud and other material to, for example, the mud tank 301.

In the example system of FIG. 3, a borehole 332 is formed in subsurface formations 330 by rotary drilling; noting that various example embodiments may also use one or more directional drilling techniques, equipment, etc.

As shown in the example of FIG. 3, the drillstring 325 is suspended within the borehole 332 and has a drillstring assembly 350 that includes the drill bit 326 at its lower end. As an example, the drillstring assembly 350 may be a bottom hole assembly (BHA).

The wellsite system 300 can provide for operation of the drillstring 325 and other operations. As shown, the wellsite system 300 includes the traveling block 311 and the derrick 314 positioned over the borehole 332. As mentioned, the wellsite system 300 can include the rotary table 320 where the drillstring 325 pass through an opening in the rotary table 320.

As shown in the example of FIG. 3, the wellsite system 300 can include the kelly 318 and associated components, etc., or the top drive 340 and associated components. As to a kelly example, the kelly 318 may be a square or hexagonal metal/alloy bar with a hole drilled therein that serves as a mud flow path. The kelly 318 can be used to transmit rotary motion from the rotary table 320 via the kelly drive bushing 319 to the drillstring 325, while allowing the drillstring 325 to be lowered or raised during rotation. The kelly 318 can pass through the kelly drive bushing 319, which can be driven by the rotary table 320. As an example, the rotary table 320 can include a master bushing that operatively couples to the kelly drive bushing 319 such that rotation of the rotary table 320 can turn the kelly drive bushing 319 and hence the kelly 318. The kelly drive bushing 319 can include an inside profile matching an outside profile (e.g., square, hexagonal, etc.) of the kelly 318; however, with slightly larger dimensions so that the kelly 318 can freely move up and down inside the kelly drive bushing 319.

As to a top drive example, the top drive 340 can provide functions performed by a kelly and a rotary table. The top drive 340 can turn the drillstring 325. As an example, the top drive 340 can include one or more motors (e.g., electric and/or hydraulic) connected with appropriate gearing to a short section of pipe called a quill, that in turn may be screwed into a saver sub or the drillstring 325 itself. The top drive 340 can be suspended from the traveling block 311, so the rotary mechanism is free to travel up and down the derrick 314. As an example, a top drive 340 may allow for drilling to be performed with more joint stands than a kelly/rotary table approach.

In the example of FIG. 3, the mud tank 301 can hold mud, which can be one or more types of drilling fluids. As an example, a wellbore may be drilled to produce fluid, inject fluid or both (e.g., hydrocarbons, minerals, water, etc.).

In the example of FIG. 3, the drillstring 325 (e.g., including one or more downhole tools) may be composed of a series of pipes threadably connected together to form a long tube with the drill bit 326 at the lower end thereof. As the drillstring 325 is advanced into a wellbore for drilling, at some point in time prior to or coincident with drilling, the mud may be pumped by the pump 304 from the mud tank 301 (e.g., or other source) via the lines 306, 308 and 309 to a port of the kelly 318 or, for example, to a port of the top drive 340. The mud can then flow via a passage (e.g., or passages) in the drillstring 325 and out of ports located on the drill bit 326 (see, e.g., a directional arrow). As the mud exits the drillstring 325 via ports in the drill bit 326, it can then circulate upwardly through an annular region between an outer surface(s) of the drillstring 325 and surrounding wall(s) (e.g., open borehole, casing, etc.), as indicated by directional arrows. In such a manner, the mud lubricates the drill bit 326 and carries heat energy (e.g., frictional or other energy) and formation cuttings to the surface where the mud (e.g., and cuttings) may be returned to the mud tank 301, for example, for recirculation (e.g., with processing to remove cuttings, etc.).

The mud pumped by the pump 304 into the drillstring 325 may, after exiting the drillstring 325, form a mudcake that lines the wellbore which, among other functions, may reduce friction between the drillstring 325 and surrounding wall(s) (e.g., borehole, casing, etc.). A reduction in friction may facilitate advancing or retracting the drillstring 325. During a drilling operation, the entire drillstring 325 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 326 of the drillstring 325 at a bottom of a wellbore, pumping of the mud commences to lubricate the drill bit 326 for purposes of drilling to enlarge the wellbore. As mentioned, the mud can be pumped by the pump 304 into a passage of the drillstring 325 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulate. In such an example, information from downhole equipment (e.g., one or more modules of the drillstring 325) may be transmitted uphole to an uphole device, which may relay such information to other equipment for processing, control, etc.

As an example, telemetry equipment may operate via transmission of energy via the drillstring 325 itself. For example, consider a signal generator that imparts coded energy signals to the drillstring 325 and repeaters that may receive such energy and repeat it to further transmit the coded energy signals (e.g., information, etc.).

As an example, the drillstring 325 may be fitted with telemetry equipment 352 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 3, an uphole control and/or data acquisition system 362 may include circuitry to sense pressure pulses generated by telemetry equipment 352 and, for example, communicate sensed pressure pulses or information derived therefrom for process, control, etc.

The assembly 350 of the illustrated example includes a logging-while-drilling (LWD) module 354, a measurement-while-drilling (MWD) module 356, an optional module 358, a rotary-steerable system (RSS) and/or motor 360, and the drill bit 326. Such components or modules may be referred to as tools where a drillstring can include a plurality of tools.

As to an RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling can commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor can present some challenges depending on factors such as rate of penetration (ROP), transferring weight to a bit (e.g., weight on bit, WOB) due to friction, etc. A mud motor can be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM can be determined or estimated as a sum of the SRPM and the mud motor RPM, assuming the SRPM and the mud motor RPM are in the same direction.

As an example, a PDM mud motor can operate in a so-called sliding mode, when the drillstring is not rotated from the surface. In such an example, a bit RPM can be determined or estimated based on the RPM of the mud motor.

An RSS can drill directionally where there is continuous rotation from surface equipment, which can alleviate the sliding of a steerable motor (e.g., a PDM). An RSS may be deployed when drilling directionally (e.g., deviated, horizontal, or extended-reach wells). An RSS can aim to minimize interaction with a borehole wall, which can help to preserve borehole quality. An RSS can aim to exert a relatively consistent side force akin to stabilizers that rotate with the drillstring or orient the bit in the desired direction while continuously rotating at the same number of rotations per minute as the drillstring.

The LWD module 354 may be housed in a suitable type of drill collar and can contain one or a plurality of selected types of logging tools. It will also be understood that more than one LWD and/or MWD module can be employed, for example, as represented by the module 356 of the drillstring assembly 350. Where the position of an LWD module is mentioned, as an example, it may refer to a module at the position of the LWD module 354, the module 356, etc. An LWD module can include capabilities for measuring, processing, and storing information, as well as for communicating with the surface equipment. In the illustrated example, the LWD module 354 may include a seismic measuring device.

The MWD module 356 may be housed in a suitable type of drill collar and can contain one or more devices for measuring characteristics of the drillstring 325 and the drill bit 326. As an example, the MWD tool 354 may include equipment for generating electrical power, for example, to power various components of the drillstring 325. As an example, the MWD tool 354 may include the telemetry equipment 352, for example, where the turbine impeller can generate power by flow of the mud; it being understood that other power and/or battery systems may be employed for purposes of powering various components. As an example, the MWD module 356 may include one or more of the following types of measuring devices: a weight-on-bit measuring device, a torque measuring device, a vibration measuring device, a shock measuring device, a stick slip measuring device, a direction measuring device, and an inclination measuring device.

FIG. 3 also shows some examples of types of holes that may be drilled. For example, consider a slant hole 372, an S-shaped hole 374, a deep inclined hole 376 and a horizontal hole 378.

As an example, a drilling operation can include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring can include a positive displacement motor (PDM).

As an example, a system may be a steerable system and include equipment to perform methods such as geosteering. As mentioned, a steerable system can be or include an RSS. As an example, a steerable system can include a PDM or a turbine on a lower part of a drillstring which, just above a drill bit, a bent sub can be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment, for example, to follow a desired route to reach a desired target or targets.

As an example, a drillstring can include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering can include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 3, the wellsite system 300 can include one or more sensors 364 that are operatively coupled to the control and/or data acquisition system 362. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 300. As an example, a sensor or sensor may be at an offset wellsite where the wellsite system 300 and the offset wellsite are in a common field (e.g., oil and/or gas field).

As an example, one or more of the sensors 364 can be provided for tracking pipe, tracking movement of at least a portion of a drillstring, etc. As an example, the system 300 can include one or more sensors 366 that can sense and/or transmit signals to a fluid conduit such as a drilling fluid conduit (e.g., a drilling mud conduit). For example, in the system 300, the one or more sensors 366 can be operatively coupled to portions of the standpipe 308 through which mud flows. As an example, a downhole tool can generate pulses that can travel through the mud and be sensed by one or more of the one or more sensors 366. In such an example, the downhole tool can include associated circuitry such as, for example, encoding circuitry that can encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 300 can include a transmitter that can generate signals that can be transmitted downhole via mud (e.g., drilling fluid) as a transmission medium.

As an example, one or more portions of a drillstring may become stuck. The term stuck can refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, this can refer to a portion of a drillstring that cannot be rotated or moved axially. As an example, a condition referred to as “differential sticking” can be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking can have time and financial cost.

As an example, a sticking force can be a product of the differential pressure between the wellbore and the reservoir and the area that the differential pressure is acting upon. This means that a relatively low differential pressure (delta p) applied over a large working area can be just as effective in sticking pipe as can a high differential pressure applied over a small area.

As an example, a condition referred to as “mechanical sticking” can be a condition where limiting or prevention of motion of the drillstring by a mechanism other than differential pressure sticking occurs. Mechanical sticking can be caused, for example, by one or more of junk in the hole, wellbore geometry anomalies, cement, keyseats or a buildup of cuttings in the annulus. One or more techniques, control algorithms, etc., may be implemented during drilling to reduce risks of issues that may result in non-productive time (NPT). As an example, a system such as the system 100 of FIG. 1 may be utilized before, during or after drilling for purposes of reducing risks (e.g., via simulation, control, etc.).

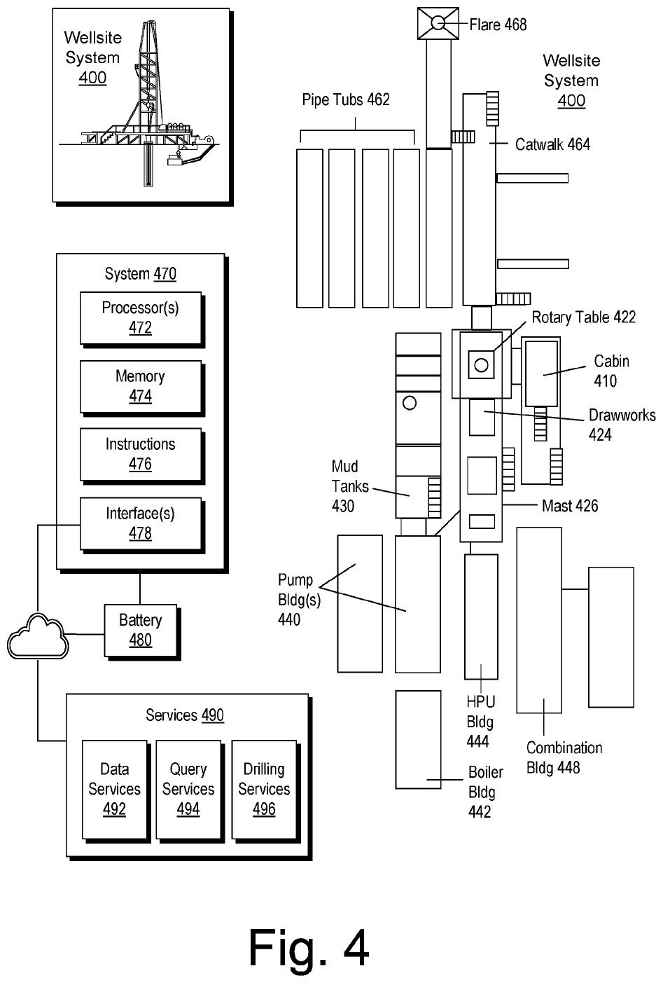

FIG. 4 shows an example of a wellsite system 400, specifically, FIG. 4 shows the wellsite system 400 in an approximate side view and an approximate plan view along with a block diagram of a system 470, where the wellsite system 400 can include one or more features of the wellsite system 300 of FIG. 3.

In the example of FIG. 4, the wellsite system 400 can include a cabin 410, a rotary table 422, drawworks 424, a mast 426 (e.g., optionally carrying a top drive, etc.), mud tanks 430 (e.g., with one or more pumps, one or more shakers, etc.), one or more pump buildings 440, a boiler building 442, an HPU building 444 (e.g., with a rig fuel tank, etc.), a combination building 448 (e.g., with one or more generators, etc.), pipe tubs 462, a catwalk 464, a flare 468, etc. Such equipment can include one or more associated functions and/or one or more associated operational risks, which may be risks as to time, resources, and/or humans.

As shown in the example of FIG. 4, the wellsite system 400 can include a system 470 that includes one or more processors 472, memory 474 operatively coupled to at least one of the one or more processors 472, instructions 476 that can be, for example, stored in the memory 474, and one or more interfaces 478. As an example, the system 470 can include one or more processor-readable media that include processor-executable instructions executable by at least one of the one or more processors 472 to cause the system 470 to control one or more aspects of the wellsite system 400. In such an example, the memory 474 can be or include the one or more processor-readable media where the processor-executable instructions can be or include instructions. As an example, a processor-readable medium can be a computer-readable storage medium that is not a signal and that is not a carrier wave.

FIG. 4 also shows a battery 480 that may be operatively coupled to the system 470, for example, to power the system 470. As an example, the battery 480 may be a back-up battery that operates when another power supply is unavailable for powering the system 470. As an example, the battery 480 may be operatively coupled to a network, which may be a cloud network. As an example, the battery 480 can include smart battery circuitry and may be operatively coupled to one or more pieces of equipment via a SMBus or other type of bus.

In the example of FIG. 4, services 490 are shown as being available, for example, via a cloud platform. Such services can include data services 492, query services 494 and drilling services 496. As an example, the services 490 may be part of a system such as the system 100 of FIG. 1.

As an example, the system 470 may be utilized to generate one or more rate of penetration drilling parameter values, which may, for example, be utilized to control one or more drilling operations. As an example, the system 470 may be utilized to reduce risks as to one or more types of issues.

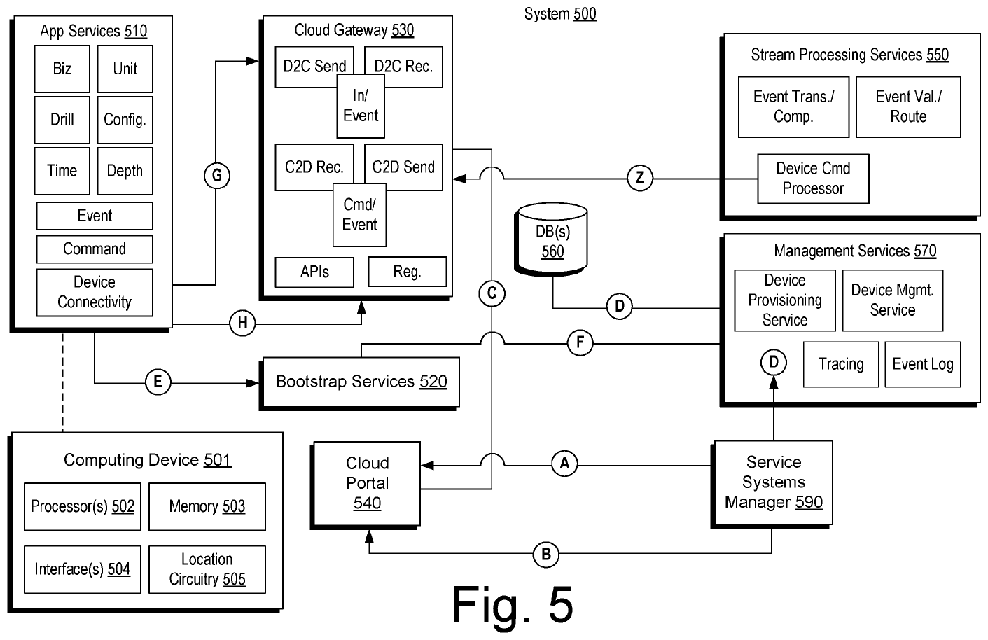

FIG. 5 shows an example of a system 500 that includes a computing device 501, an application services block 510, a bootstrap services block 520, a cloud gateway block 530, a cloud portal block 540, a stream processing services block 550, one or more databases 560, a management services block 570 and a service systems manager 590.

In the example of FIG. 5, the computing device 501 can include one or more processors 502, memory 503, one or more interfaces 504 and location circuitry 505 or, for example, one of the one or more interfaces 504 may be operatively coupled to location circuitry that can acquire local location information. For example, the computing device 501 can include GPS circuitry as location circuitry such that the approximate location of the computer device 501 can be determined. While GPS is mentioned (Global Positioning System), location circuitry may employ one or more types of locating techniques. For example, consider one or more of GLONASS, GALILEO, BeiDou-2, or another system (e.g., global navigation satellite system, “GNSS”). As an example, location circuitry may include cellular phone circuitry (e.g., LTE, 3G, 4G, etc.). As an example, location circuitry may include WiFi circuitry.

As an example, the application services block 510 can be implemented via instructions executable using the computing device 501. As an example, the computing device 501 may be at a wellsite and part of wellsite equipment. As an example, the computing device 501 may be a mobile computing device (e.g., tablet, laptop, etc.) or a desktop computing device that may be mobile, for example, as part of wellsite equipment (e.g., doghouse equipment, rig equipment, vehicle equipment, etc.).

As an example, the system 500 can include performing various actions. For example, the system 500 may include a token that is utilized as a security measure to assure that information (e.g., data) is associated with appropriate permission or permissions for transmission, storage, access, etc.

In the example of FIG. 5, various circles are shown with labels A to H. As an example, A can be a process where an administrator creates a shared access policy (e.g., manually, via an API, etc.); B can be a process for allocating a shared access key for a device identifier (e.g., a device ID), which may be performed manually, via an API, etc.); C can be a process for creating a “device” that can be registered in a device registry and for allocating a symmetric key; D can be a process for persisting metadata where such metadata may be associated with a wellsite identifier (e.g., a well ID) and where, for example, location information (e.g., GPS based information, etc.) may be associated with a device ID and a well ID; E can be a process where a bootstrap message passes that includes a device ID (e.g., a trusted platform module (TPM) chip ID that may be embedded within a device) and that includes a well ID and location information such that bootstrap services (e.g., of the bootstrap services block 520) can proceed to obtain shared access signature (SAS) key(s) to a cloud service endpoint for authorization; F can be a process for provisioning a device, for example, if not already provisioned, where, for example, the process can include returning device keys and endpoint; G can be a process for getting a SAS token using an identifier and a key; and H can be a process that includes being ready to send a message using device credentials. Also shown in FIG. 5 is a process for getting a token and issuing a command for a well identifier (see label Z).

As an example, Shared Access Signatures can be an authentication mechanism based on, for example, SHA-256 secure hashes, URIs, etc. As an example, SAS may be used by one or more Service Bus services. SAS can be implemented via a Shared Access Policy and a Shared Access Signature, which may be referred to as a token. As an example, for SAS applications using the AZURE .NET SDK with the Service Bus, .NET libraries can use SAS authorization through the SharedAccessSignatureTokenProvider class.

As an example, where a system gives an entity (e.g., a sender, a client, etc.) a SAS token, that entity will not have the key directly, and that entity cannot reverse the hash to obtain it. As such, there is control over what that entity can access and, for example, for how long access may exist. As an example, in SAS, for a change of the primary key in the policy, Shared Access Signatures created from it will be invalidated.

As an example, the system 500 of FIG. 5 can be implemented for provisioning of one or more pieces of equipment, which may be rig equipment, wireline equipment, production equipment, fracturing equipment, etc.

As an example, a method can include establishing an Internet of Things (IoT) hub or hubs. As an example, such a hub or hubs can include one or more device registries. In such an example, the hub or hubs may provide for storage of metadata associated with a device and, for example, a per-device authentication model. As an example, where location information indicates that a device (e.g., wellsite equipment, etc.) has been changed with respect to its location, a method can include revoking the device in a hub.

As an example, an architecture utilized in a system such as, for example, the system 500, may include features of the AZURE architecture and/or one or more other cloud architectures (e.g., GOOGLE CLOUD, AMAZON WEB SERVICES CLOUD, etc.). As an example, the cloud portal block 540 can include one or more features of an AZURE portal that can manage, mediate, etc. access to one or more services, data, connections, networks, devices, etc.

As an example, the system 500 can include a cloud computing platform and infrastructure, for example, for building, deploying, and managing applications and services (e.g., through a network of datacenters, etc.). As an example, such a cloud platform may provide PaaS and IaaS services and support one or more different programming languages, tools and frameworks, etc.

As explained, various features of the system 100 of FIG. 1 can be cloud-based. As an example, the system 100 may be operable using one or more features of the system 500. As an example, the DELFI cognitive E&P environment may be implemented at least in part in a cloud platform that includes one or more features of the system 500.

As an example, a cloud platform may provide various compute tools, management tools, networking tools, storage and database tools, large data tools, identity and security tools, and machine learning tools. In the GOOGLE CLOUD platform, when an application requests private data, the request is to be authorized by an authenticated entity that has access to the data, which can be part of an OAuth 2.0 flow. In various instances where an application is not demanding access to data, a system may utilize a server-centric OAuth 2.0 flow based on a service account. OAuth 2.0 is an industry-standard protocol for authorization. OAuth 2.0 provides specific authorization flows for web applications, desktop applications, mobile phones, living room devices, etc.

As an example, a request that an application sends to a cloud storage JSON application programming interface (API) that demands authorization can be identified using one or more techniques, such as, for example, by using an OAuth 2.0 token (which also authorizes the request) and/or using the application's API key.

As an example, if a request demands authorization (such as a request for private data), then an application may be required to provide an OAuth 2.0 token with the request; noting that the application may also provide the API key. As an example, if a request is not demanding authorization (e.g., a request for public data), then no identification is demanded; however, the application may still provide the API key, an OAuth 2.0 token, or both. As an example, an application in the GOOGLE CLOUD platform can use OAuth 2.0 to authorize requests.

As explained, various types of operations can depend on various types of equipment, processes, individuals, etc., which may be in various locations (e.g., within a country, internationally, on land, at sea, etc.). Operations can be complex and interdependent where various types of frameworks may be utilized by individuals to manage, monitor, control, etc., such operations. At times, questions may arise as to one or more operations, whether during planning, execution, monitoring, etc. For example, in the context of drilling, a driller may be utilizing a drilling operations framework that can render information as to drilling at a rigsite. As explained, the driller may want to reduce risk of sticking but the driller may be unsure as to one or more factors associated with risk and/or how to operate drilling equipment to mitigate risk. In such an example, the framework can be operatively coupled to a communications framework, which may span multiple frameworks. For example, a graphical user interface (GUI) may be rendered to a display where the driller can interact with the GUI to invoke one or more features of the communications framework. In such an example, the driller may type a question into a discussion field of a GUI and may select one or more options in an effort to reach a subject matter expert (SME). In response, the communications framework can intelligently associate context with the driller's request. For example, consider one or more types of sensor data, equipment specifications, drilling conditions, etc., as being associated with the driller's request where such data may be stored within a storage device and/or be within a domain of a framework or frameworks (e.g., consider framework generated data, etc.). As explained, security may be implemented such that access to various data occurs in an authorized manner (e.g., using tokens, secure networks, one or more TPM chips, etc.). As to access to an SME, the communications framework may indicate availability information such as, for example, wait time, time available, security level, etc. As an example, the SME and/or the requester may set one or more-time constraints such as, for example, a constraint that limits a discussion time to a number of minutes, hours, etc. As an example, a time constraint can be based on one or more factors (e.g., scheduling factors, security factors, cost factors, risk factors etc.). In such an example, the SME may be available to serve a number of drillers, which may be at a number of sites. As an example, a communications framework may acquire data during a request, during an interaction, etc., which, as explained, may be stored data. Stored data may be utilized for purposes of enhancing one or more frameworks, for example, consider enhancing a framework via training of one or more machine learning models to generate one or more trained machine learning models. As an example, a trained machine learning model may be deployed within a framework and/or may be part of a communications framework. Stored data may be utilized in one or more manners to improve various operations, which may be on a field scale, a national scale, a global scale, etc.

In the context of oil and gas operations, as explained, frameworks can be utilized for operations involving various types of equipment. For example, consider types of equipment that can range from electric submersible pumps (ESPs) to subsea processing systems and from acid-gas membranes to isolation valves. As an example, a services company may facilitate operations that may be performed by clients of the services company. A framework such as the aforementioned example communications framework may ease a client's ability to reach out to the service company and its SMEs. For example, such a framework may make it easier for a client to raise a question in a timely manner, before equipment or conditions deteriorate, which may lead to a different, more costly outcome (e.g., materialization of one or more issues and/or heightened management of risks). Referring to the sticking example, a client may readily reach out via a communications framework to assess risk of sticking before sticking actually occurs. In such an example, the client may know how to handle the costly process of “unsticking” yet may not know exactly how to reduce risk of sticking such that sticking will not occur. As such, early, timely intervention via consultation with an SME can result in substantial efficiencies, including reduction in non-productive time (NPT).

As an example, requests may be made by machines automatically and/or via human interaction. For example, where a control system for a drilling operation indicates an increased risk of an issue occurring, the control system may automatically generate a request, which may be sent automatically and/or after review by a driller. In such an example, the control system may formulate a request and include data and/or links to data germane to the request. As an example, a request may demand entry of a security credential prior to transmission, which may be entered by a driller or other operator as a safeguard such that a control system will not issue more requests than appropriate with respect to budget, timing, etc. As explained, a goal can be to reduce non-productive time (NPT) noting that a request can come at a trade-off in that information responsive to a request may help to reduce risk of an issue and/or solve an issue but with some amount of delay for the request to be processed and responded to. As such, a system can include various features that help to reduce such delays, which can be via effective network communications, data access, etc., techniques. Such an approach can help a driller or other operator to make decisions as to whether or not to send a request in a more reliable manner. For example, if a system can generate assurances as to data, security, timings, level of expertise, then a driller or other operator (e.g., a client, etc.) can better assess various factors in making and/or formulating a request. Such an approach can improve utilization of requests and requests themselves, along with responses to requests.

As an example, a framework can include features of a process operations framework, which may handle one or more types of processes. For example, consider a surface network operations framework, a drilling operations framework, a hydraulic fracturing operations framework, etc. As explained, a framework can utilize cloud-based resources and may provide for monitoring, health and performance insights, etc., within a midstream domain. As an example, process operations features may allow a client to monitor and be alerted to changes in the health of the installed equipment; or allow a client to investigate what-if scenarios to understand if the client has the capacity to meet future process operations demands. In such an environment, the framework features can actually increase a desire for interaction with SMEs as the client is more informed as to what is happening, often in real time. As explained, a communications framework can provide features that can facilitate such interactions.

A communications framework may also provide client benefits in scenarios where certain individuals are no longer available, for example, due to retirement, etc. In such a scenario, access to SMEs can ease the burden on a client and help to get individuals up to speed. As to another scenario, consider an increase in remote work, which may be performed in a more isolated environment rather than in a corporate setting. For example, the COVID-19 pandemic resulted in unprecedented pricing for oil and a very swift change in many aspects of life: telecommuting, regionalized supply chain, and greater investment in renewable energy. With such uncertainties and/or isolation, a client can benefit from access to SMEs, which may help to keep the client informed and engaged, along with being aware of available services, whether existing or new.

As an example, a communications framework can provide collaborative features throughout a number of applications (e.g., frameworks, etc.), in which users can discuss technical insights and reach out to SMEs for guidance (e.g., as to features offered by an application, service features, etc.). Such a communication framework can provide for internal and external collaborations.

As explained, a communication framework can include features that can attach an immediately quantifiable value and demand to a client-requested collaboration with one or more SMEs. With availability of a consistent delivery platform, various tasks can be performed more readily (e.g., data handling, security, tracking, billing, monetizing, new product/service development/deployment, etc.).

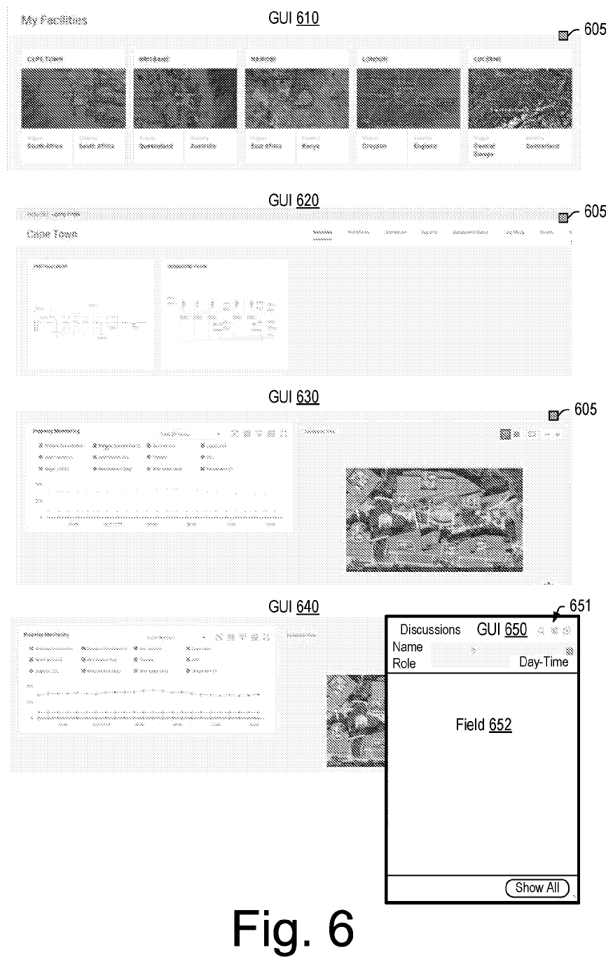

FIG. 6 shows an example of a system 600 along with various examples of graphical user interfaces 610, 620, 630, 640 and 650. In the example of FIG. 6, a graphical control 605 can provide for actuation of a communications framework that can provide for various GUI interactions (e.g., via one or more controls, settings, etc. 651). The system 600 may be operatively coupled to a system such as, for example, the system 100 of FIG. 1 and/or may utilize one or more features of a system such as, for example, the system 500 of FIG. 5.

In the example of FIG. 6, the GUI 610 includes various graphics that represent facilities in various locations; the GUI 620 shows various equipment, operations, etc., at a selected one of the facilities (e.g., “Cape Town”); and the GUI 630 shows various plots of values associated with one or more operations. For example, the plots include values for methane concentrations, mole fraction C2, stage cut CO2, mole fraction CO2, wind direction, gas detection, pressure, wind speed, liquid level, CO2, temperature, etc. Such values can be acquired via one or more types of sensors that can be installed at a facility. In the example GUI 630, various options exist as to time scale of the plots such as, for example, one hour, 24 hours, one week, one month, etc. As shown, a GUI may include a photograph and/or other type of visualization of a facility (e.g., via imagery, CAD, etc.). As an example, the GUI may include an interactive visualization, for example, with selectable graphical controls, renderable markers, etc. As explained, a GUI can include various types of information, which may be considered contextual. The GUI 640 shows the GUI 630 with an overlay of the GUI 650, which can be invoked via the graphical control 605. As shown, the GUI 650 can include the controls, settings, etc., 651 and a field 652, which can be suitable for entry of information. For example, consider typed information, drag-n-dropped information, uploaded information, etc. The GUI 650 can include information such as name, role, day, time, etc. The GUI 650 may be sized such that a user can view other information in the GUI 640 or GUIs where, for example, a “show all” button may be available for expanding the GUI 650 to show the information that has been entered (e.g., by the user, by one or more SMEs, etc.).

As an example, the invocation of the GUI 650 may cause one or more types of information to be accessed. For example, consider access to one or more values from one or more plots, one or more graphics, one or more photographs, etc. As an example, consider a user typing a query that mentions the word “pressure” where an underlying GUI may be screen captured (e.g., in whole and/or in part) and subject to optical character recognition (e.g., as appropriate) to identify pressure information therein or otherwise associated therewith. As an example, a method can include accessing one or more types of underlying information associated with a GUI (e.g., html, xml, CSS, objects, etc.). As an example, where pressure is mentioned in a question raised by a user, a method can include accessing pressure information and, for example, generating a link (e.g., a hyperlink) to such information and/or generating a value and/or identifier for insertion in the question. For example, consider the question: “Is the pressure at valve 23 too high?” As an example, the question may be transformed into: “Is the pressure [0.21 MPa] at valve 23 [choke valve] too high?” As an example, a link may be added that can be actuated, for example, to cause rendering of a plot: “Is the pressure [0.21 MPa] at valve 23 [choke valve] too high [plot]?” In such an approach, the user can easily type in a question where context can be added, optionally in an automated manner that is based on information in an underlying GUI or GUIs of a framework. As explained, in various instances, a machine may automatically formulate a request, which may be transmitted automatically or after review by an operator (e.g., optionally with entry of one or more credentials, etc.). Where context is added to a request, a SME may be able to expeditiously respond to a user's question. In the foregoing example, a SME may click on the plot link and view a trend of pressure values with respect to time, while understanding that the valve is a choke valve. The SME may understand what the trend in pressure values means and provide a more accurate and informed response in a minimal amount of time (e.g., to reduce delay, NPT, etc.).

In the foregoing example, where a communications framework collects such interactions, the interactions may be analyzed, for example, in an effort to improve services, which may include self-help options, one or more additional framework features (e.g., revised alerts, etc.), one or more new services, etc.

As an example, where a considerable wait time exists for access to a SME, a communications framework may provide a “browse” option whereby a user can browse information in a database as to one or more similar queries, which may answer the user's question and thereby allow the user to cancel the SME request. For example, where a wait time is 15 minutes to access a SME, a user may select a browse feature to browse similar questions and responses, which may be filtered (e.g., for the same facility, for similar equipment, etc.). In such an approach, the user may become more informed and be able to interact with the SME more readily to arrive at an appropriate course of action. While the foregoing example is with respect to pressure, consider the sticking example, which may be with respect to drilling. As explained, a communications framework may be suitable for use with one or more other frameworks, which may be provided for oil and gas operations and/or other industrial operations (e.g., chemical processing, pharmaceutical processing, equipment manufacturing, etc.).

As explained, a communications framework can provide for contextualization of SME collaborative support based on user action and location/screen of application navigation (e.g., within a framework, a framework environment, etc.). As an example, a communications framework can help reduce instances of duplicate inquiries by the ability to access queries relating to the same or similar screen/context (e.g., consider search, fuzzy search, AI search, etc.). As explained, a communications framework can provide for recording of historical queries for forensic and/or other purposes. Such an approach can provide for creation of knowledge content based on various SME support scenarios, which may be utilized for AI training and/or automated support (e.g., bot, etc.).

As an example, a communications framework can provide for routing questions to an appropriate expert/domain based at least in part on context of a question. In such an example, one or more approaches may provide for such routing. For example, consider utilization of context in an underlying GUI or GUIs, utilization of words and/or other content placed into a field or fields (see, e.g., the field 652 of the GUI 650). As an example, one or more trained machine learning models (trained ML models) may provide for classification of a question where based on classification a particular SME and/or domain is/are assigned.

As explained, a communications framework can include various features for tracking interactions. For example, consider an ability to track/charge time of SME support services through the tracking of live interaction. In such an example, a user may have a budget and may be able to request an increase to the budget if appropriate. For example, where a user is at or near a budget limit, a request for access to a SME may automatically generate a budget increase request that is transmitted to an appropriate authority, which may be available online and be able to readily assess the budget increase request. In such an example, some amount of context may be transmitted, optionally along with the query, such that the authority can assess the request as to urgency, relevance, etc. Such an approach may also be utilized to assess knowledge and/or capabilities of the user, for example, to see what types of questions the user has raised and/or why/where the user spent the existing budget. An analysis of information may provide for opportunities for education, additional workforce, additional equipment, additional services, etc. Where a budget increase request is approved, the user's query may be automatically transmitted for assignment to an appropriate SME, optionally with one or more constraints (e.g., limited to 30 minutes, etc.).

A communications framework may be utilized for one or more types of physical facilities/assets, exploration, operations, etc. (e.g., oil and gas, pharmaceutical, food, equipment, etc.), for example, where one or more computational frameworks exist with different features/pages and where domain experts (SMEs) exist, knowledgeable about the facilities/assets, exploration, operations, etc., and/or the one or more computational frameworks.

As an example, a communications framework can enable a collaboration session where, for example, a collaboration tool is available on different pages (e.g., the tool stays the same while a user may navigate from one page to another). In such an example, a user can invoke the collaboration tool and type in a question, etc., optionally in a manner where the user can control time to be spent/billed. As explained, a collaboration tool can return a SME, availability, etc. (e.g., and/or suggest based on question, page, etc.). As an example, a communications framework can provide for placement of a call or invocation of a live session. As to a live session, consider a web-based application such as MS TEAMS where one or more APIs may be available to commence a session if desired (screen share, etc.). As an example, a session may involve virtual reality and/or augmented reality (e.g., consider a display headset-based session, etc.).

As explained, a method can provide for page GUI element integration (XML, etc.) for content/context. As explained, one or more types of intelligence may be gleaned from interactions, underlying frameworks, etc. (e.g., glean context from page such as pressure is a pressure reading rendered to GUI on page, etc.). As explained, a communications framework may provide a user with the ability to search, filter, etc.

As an example, a communications framework can provide 24-hour availability (e.g., global resources) and can manage privacy, security, etc. For example, one or more rules engines may be implemented that aim to provide access to a SME in a particular region with a particular level of security. Such an approach may aim to comply with various regulations. As an example, a communications framework may operate based on privilege to access one or more computational frameworks. For example, an SME may be associated with one or more licenses for use of a computational framework and/or may be able to “share” a license from a requestor for a period of time sufficient to respond to a request. In such an example, a request may include license information and conditions as to whether or not one or more SMEs may utilize a license of the requestor and/or whether a matched SME is to have a license or licenses to respond to a request.

As mentioned, a communications framework can provide for early intervention, which may be before a failure occurs. As an example, such a framework may provide for scheduling maintenance, repair, delivery of material, equipment, people, etc. For example, where a discussion involves an issue related to wear of equipment (e.g., a drill bit, etc.), a communications framework may provide for appending information to a question such as, for example: “Will this change the scheduled replacement time [March 30] for the drill bit?” In such an example, the scheduled replacement time may be automatically added via access to underlying content. Such an approach may allow for consolidation of issues and/or more complete questioning of a SME. Such an approach may conserve resources of a user, particularly where access to a SME may be on the basis of a minimum time increment (e.g., 30 minutes, etc.). Thus, by appending one or more additional questions to an initial question, where such one or more additional questions may be relatively quick to answer (e.g., a few minutes or less), a time increment can be more effectively utilized (e.g., to improve operations, etc.).

As explained, various types of data can be generated via utilization of a communications framework, which can include collaboration data. As explained, such data may be used for one or more purposes (e.g., AI, automated billing/invoicing, sales intelligence, service/framework improvements, routing, assigning, analogue searching, etc.). As explained, where a user has a wait time, a communications framework may identify one or more same or similar scenarios. In the context of oil and gas operations, so-called analogues may exist. For example, one field may have a stratigraphy similar to another field such that what exists in the two fields is somewhat analogous. In such an example, a trained machine learning model may receive input from a user's framework to search for analogues (e.g., via classification, etc.). Once one or more analogues are found, a database as to queries may be searched. Hence, a tiered approach to identification of relevant information may be applied. In such an example, the identification of relevant information may be performed in a manner of a few minutes or less such that the user can review such information while waiting for a SME, which, as mentioned, can help the user more specifically discuss an issue with the SME.

As an example, where a considerable wait time exists, a communications framework may identify or assign a SME where the SME may have a preliminary set of questions. For example, consider a SME that has a preliminary questionnaire as to different types of questions a user may ask. Once the SME is identified or assigned to the user's question, the preliminary questionnaire may be transmitted to the user such that answers are available by the time the SME comes online. Such an approach may help prepare the SME and the user for the discussion, which may then be more effective. Further, the questionnaire and/or responses thereto may be stored in a database, thereby being available for one or more purposes (e.g., refining the questionnaire, training users, framework improvements, etc.).

As explained, a database may provide for forensic analyses. For example, where an issue occurs after consultation with a SME, a forensic analysis may aim to determine what question or questions or answer or answers may have helped to avoid the issue. As an example, forensics may provide opportunities to understand issues as to operation integrity, equipment utilization, service schedules, etc. As an example, data may be analyzed and/or viewed from one or more perspectives (e.g., user, SME, equipment, operation, location, framework, etc.). Such data may be appropriately routed and/or analyzed and results routed for improvements. For example, consider output of suggestions for clients on how to operate more effectively, where training may be helpful, workflows for client, etc.

As explained, a framework may operate in real time (e.g., real time pressure data, drilling data, etc.). Interactions with a communications framework can be considered a type of real time data, which may provide for asset, facility, etc., monitoring (knowing where questions arise), alarms, when multiple SME requests from different perspectives for a common facility, linking users into a group if one issue is driving the questions, rendering of a dashboard of facility (e.g., to see where questions are arising), tracking wait times, setting urgency, etc.

As an example, a communications framework can provide for various benefits in the long term. For example, consider generation of an intelligent platform for managing various aspects of business and driving insights as to new opportunities and improvements. Such an approach can provide for rising to a higher level of SME engagement and value-add.

As explained, a communications framework can provide a collaboration feature integrated on multiple pages of an application like equipment overview, forecasting, reporting and events. In such an example, a tool may include a chat icon. In such an example, clicking on chat icon can open a discussions panel on which the user can view discussions and/or create one or more new ones related to the context of the selected feature. To create a new discussion, a user may provide a subject (e.g., a title) and query. The user can also add attachments and tag one or more multiple people on the discussion. In such an example, people tagged in the discussion can receive a notification (e.g., email, text, etc.) alerting the tagged users that a new discussion has been created. The users can also add comments to the discussions and tag people in their comments. For every new comment, the system can again send notifications to the person who created the discussion and people tagged in the comment. The notifications sent to the users may include one or more formats, which may provide a link to a discussion page in the application, for example, without displaying client confidential data. In such an approach, notifications can be without confidential data where a link can be processed using appropriate security protocols such that confidential data can be viewed by those with appropriate security clearance/authority.

Using a collaboration tool, a user may request interaction with a SME. In such an example, when a request is created, a communications framework can automatically transmit a notification to an appropriate SME or SMEs assigned to the client. Such an approach can provide for scheduling of a call/web-session and, once the call/web-session has been completed, a SME may update a discussion (e.g., via text entry, etc.). In such an approach, based on interaction duration and predefined SME fees, a communications framework may generate an invoice, a debit, etc. (e.g., a charge to a client as to SME consulting fees, etc.).

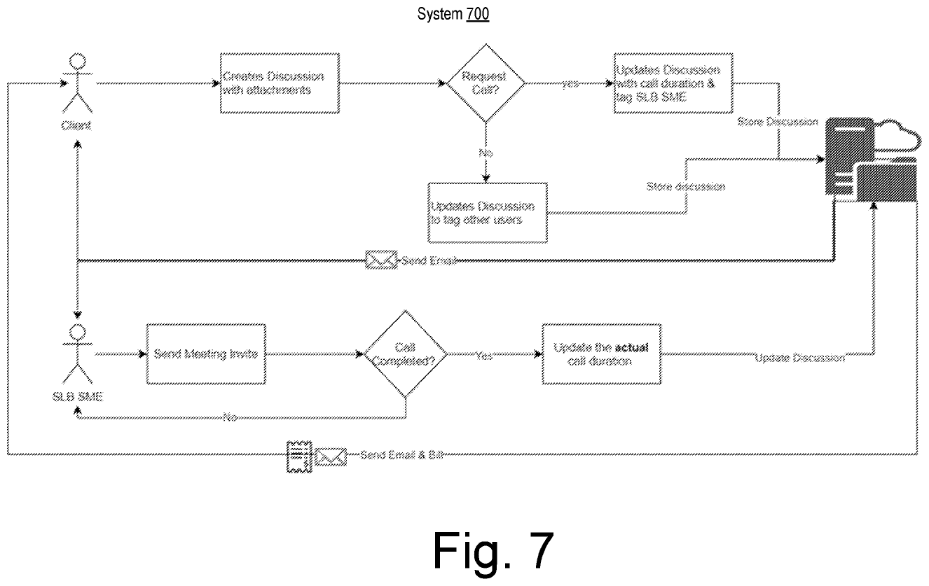

FIG. 7 shows an example of a system 700 that includes various components for interactions between a client and a SME where the client can be at a computing device utilizing a framework, which may be part of a framework environment. As shown, the client can create a discussion, optionally with one or more attachments. In a decision block, a decision is made as to whether a call is requested (e.g., voice communication via phone, web-session, etc.). Where a call is requested with a call duration, the system 700 can update a discussion with call duration and a SME tag. Where a call is not requested, interaction can be via a chat feature where the system 700 can update a discussion and tag participants of the discussion. In either instance, information can be stored. As shown in the example of FIG. 7, the system 700 can also provide for issuance of notifications (see, e.g., “email”). As shown, notifications may be issued from a database (e.g., server database), which may be responsive to a client request, which, as mentioned, may request a voice call/web-session. In such an example, a SME can receive a notification as to the request and then issue a meeting invite, for example, as to a voice call/web-session. In such an example, the SME can drive the scheduling via issuance of an invite for a voice call/web-session. Once the voice call/web-session is completed, an update can be transmitted for storage and/or further processing, which may include, for example, transmission of an invoice (e.g., a bill, etc.), which may be via email, etc.

As explained, a GUI of a framework can include a graphical control such as an icon that provides for access to features of a communications framework (e.g., a communications tool, etc.). As explained, the graphical control can be present on various pages of the framework (e.g., application), for example, consider pages such as those in the examples of FIG. 6, which may include pages for equipment overview, forecasting, scenarios, workflows, reporting, events, etc.

As explained, clicking on an icon can open a discussions panel (see, e.g., the GUI 650) on which a user can view one or more prior discussions or create one or more new ones, as may be related to the context of a page (e.g., a GUI or GUIs). To create a new discussion, a user may provide a subject (e.g., a title) and a query. A query field may be a rich text editor that can help to ensure proper formatting of discussion details. A user may also add one or more attachments to a discussion to provide more context to the discussion. As explained, a framework may provide one or more automated and/or semi-automated features for adding context (e.g., via XML, scrapping, etc.). As an example, a user can tag one or more people as being related to the discussion, which may include people from one or more companies. In such an example, each person tagged in the discussion can receive a notification alerting the tagged users that a new discussion has been created, which may be in a manner that will not share confidential data but can provide a link to the discussion (e.g., as instantiated in a GUI on a framework/application). Using such a link, a user can login and view the discussion. As an example, an option may exist for a discussion creator to edit and/or delete his/her discussions.

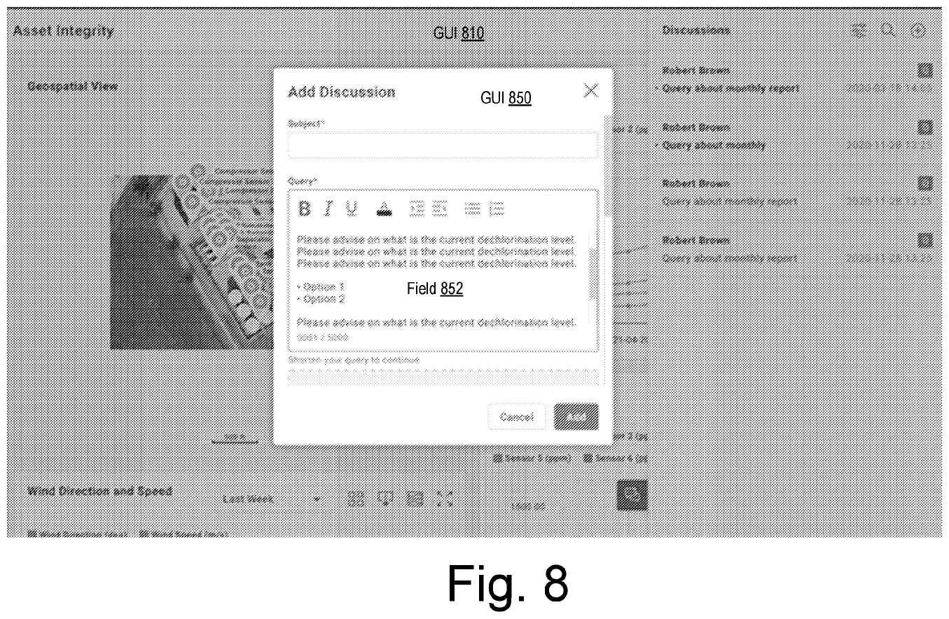

FIGS. 8, 9, 10, 11 and 12 show examples of various graphical user interfaces (GUIs) 810, 850, 852, 854, 856 and 858. In FIG. 8, the GUI 810 is a framework GUI that includes an annotated geospatial view of a facility along with plots of data where a communications framework GUI 850 is rendered with a field 852 for a discussion query (e.g., question or questions). In the example of FIG. 8, the query relates to pressure (e.g., includes the word “pressure”). As shown, an “Add” button provides for adding the discussion (e.g., creating the discussion).

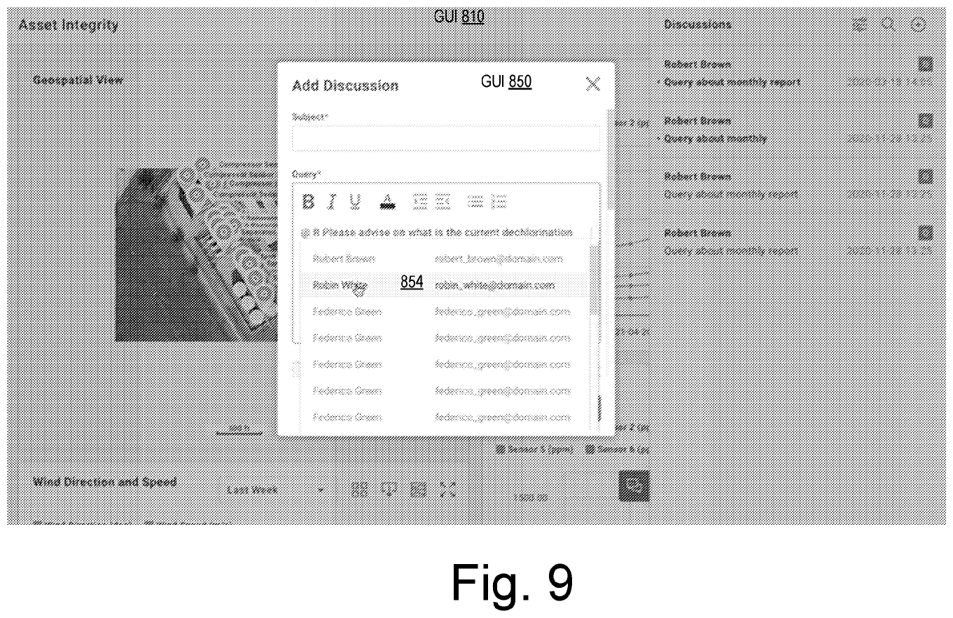

In FIG. 9, the GUI 850 includes fields 854 for individuals that can be tagged (e.g., added) to the discussion. As mentioned, the system 700 can provide for issuing notifications to tagged individuals.

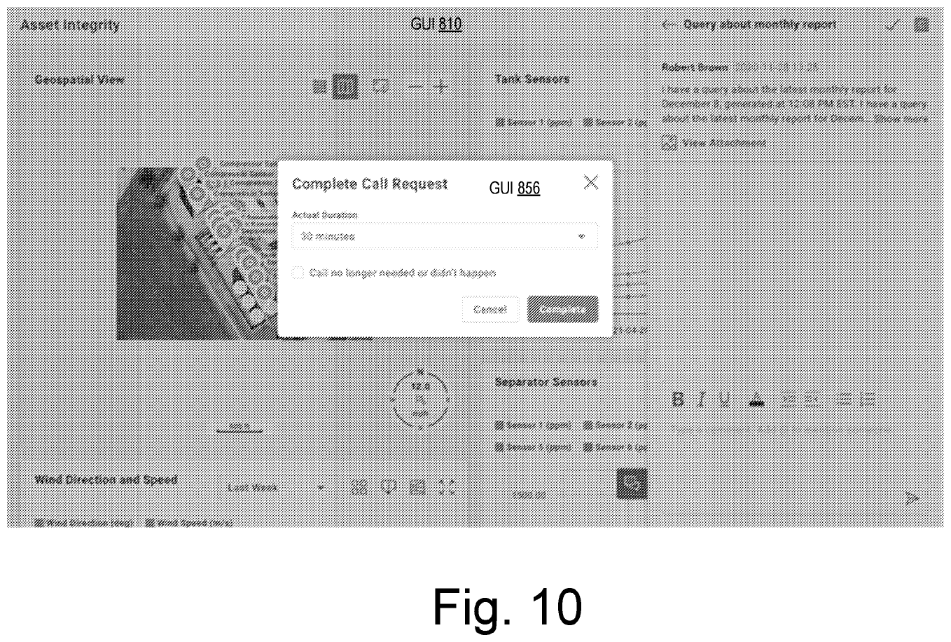

In FIG. 10, the GUI 856 is a complete call request GUI that allows for review of an actual call duration and a confirmation as to a completed status. As an example, such a GUI may be utilized for requesting a call and/or confirming a duration of a call once completed. As an example, information gained from operation of such a GUI may be utilized for improving performance, for example, via selection of SMEs, scheduling, estimating time demand in responding to requests, etc. As explained, one or more machine learning models may be trained using information gleaned through operation of a communications framework to generate one or more trained machine learning models where performance of the communications framework can be improved via use of the one or more trained machine learning models. For example, where estimated time to respond is associated with a certain type of request and particular SMEs, scheduling can be improved along with a reduction in delay and, hence, in various instances, a reduction in non-productive time (NPT).

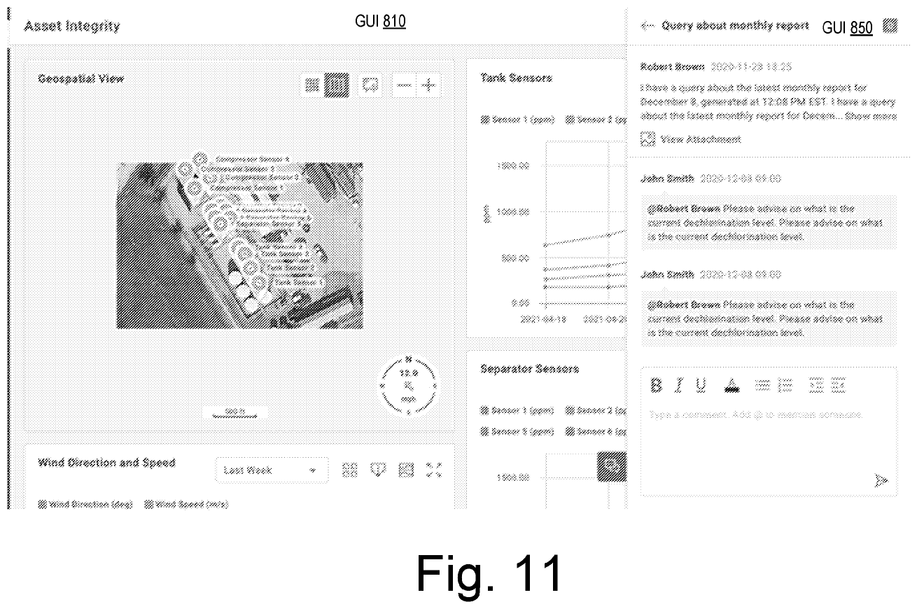

In FIG. 11, the GUI 850 includes a series of discussions, some of which can include one or more attachments. As shown, the discussions may relate to a particular topic or subject (“monthly report”). In such an approach, a user may query discussions using one or more keywords, filters, etc.

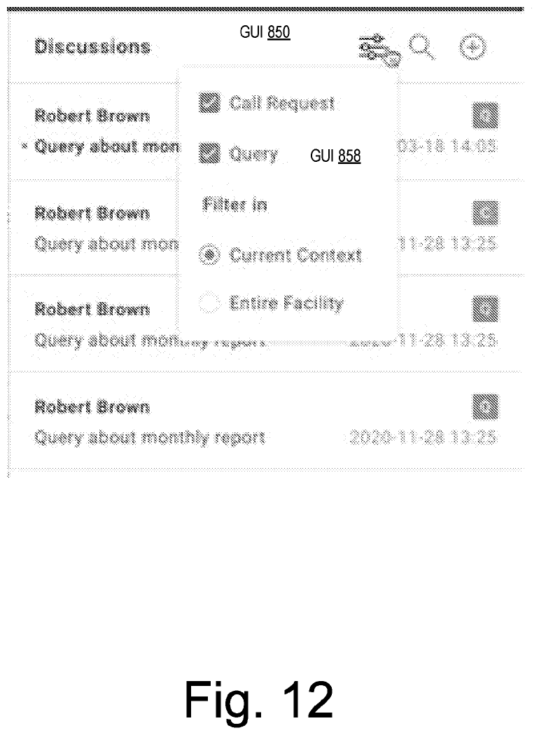

In FIG. 12, the GUI 858 shows information such as call request, query, filter, etc., which may be part of one or more features of the GUI 850. In such an approach, a user may review discussions according to one or more criteria.

As explained, a communications framework can include a request to call feature where a user can request a voice call, a web-session, etc., with at least a SME. In such an example, the user may specify a duration of time such as, for example, 30 minutes or 1 hour.

As shown in the example of FIG. 12, the GUI 858 includes a call request control graphic, a query control graphic and filter control graphics, which can include a current context control graphic and an entire facility control graphic. In such an example, a discussion GUI can display a Q (query) or a C (call) icon based on whether a call has been requested for the discussion or not. When a call request is created, a system can automatically send one or more notifications to the appropriate SME or SMEs assigned to the user (e.g., as a client) where a notification can prompt the SME or SMEs to setup a call or web-session with the user. In such an approach, once the call or web-session has been completed, the SME or SMEs can update the discussion by clicking on a complete call button (e.g., for completion of a call or web-session). In such an example, based on call duration and predefined SME rate(s), a system can generate an invoice that charges the client an appropriate fee amount. In turn, the client can assess outcomes to understand procedures, operations, controls, etc. For example, a client can assess time saved or risk avoided against delay for a response and cost. In various instances, a client may decide to address an issue with resources/assets at hand rather than making a request via a communications framework; whereas, in other instances, a client may quickly decide to make a request based on prior experience. As an example, a communications framework can include features that can assist a user in decision making, which may include cost/benefit features that account for real time availability of suitable SMEs and/or one or more delays that may be inherent in the communications framework. As explained, various factors may be considered, which can include geographic location, time of day, holidays, weather, security, access to resources, etc.

As an example, a GUI can include one or more comments features. For example, a user or users can add one or more comments to a discussion, optionally tagging one or more people in a comment. As an example, for each new comment, a system can again send a notification or notifications, for example, to the person who created the discussion and people tagged in the comment. As explained, a comment creator may be provided with an ability to edit and/or delete his/her comments.

As shown in the example GUIs 850 and 858 of FIG. 12, a control graphic of the GUI 850 may provide for opening the GUI 858, which can include various features for search and filtering. For example, such features can allow a user to search for discussions based on discussion title/subject and/or content (e.g., people, SME, client, etc.). As an example, filtering capability can allow a user to filter discussions based on type (e.g., query (Q) or call (C)) and/or based on context (e.g., current context or view a number of discussions related to the selected facility, etc.).

As an example, a communications framework can include various meeting setup features. As explained, features such as APIs may be utilized (e.g., MS TEAMS API, etc.). As an example, a communications framework may integrate one or more third party libraries so that a user can setup meeting invites directly in an application environment, which may be additional to or alternative to a request call feature. In such an example, once an invite has been sent, tagged users (e.g., one or more SMEs, etc.) will receive notifications and, for example, an option to accept or reject the meeting invite.

As an example, after a meeting is completed, based on the meeting time, a system can record billing details, which may be sent to a client. As an example, a communications framework may be integrated into a process operations environment (e.g., DELFI, etc.) where a workflow, from creating discussion, comments, to monetizing consulting time with SMEs, etc., can be accomplished within an application (e.g., framework) of a process operations environment (e.g., an environment of frameworks, etc.). As an example, a system may be configured to consolidate invoices, send consolidated invoices to a client (e.g., displaying detailed information about the consulting time and charges either on monthly or quarterly basis, etc.). As an example, a consolidated invoice may be in the form of a dataset where an application (e.g., app or web-app) can allow a client to view the information in the consolidated invoice in various manners (e.g., sorting, searching, etc.). In such an approach, the client may understand where additional opportunities may exist to improve operations.

As an example, a communications framework can provide various features for communications that can include automated context features. Such a framework can provide for automatic notifications such that a user will not have to open a separate application such as an email application; noting that an email-based approach for content (e.g., context) may put confidential information and/or regulatory compliance at risk. Where an automatic notification includes a link to a framework of a process operations environment (e.g., DELFI, etc.), the receiver of that notification may have to login securely such that trust is established before the receiver can actually be exposed to the context (e.g., confidential information, etc.). Further, as notifications can be for services (e.g., SME provided services), a communications framework can provide for automated service accounting (e.g., time, rates, invoicing, etc.). As explained, a communications framework can include or be operatively coupled to a database or databases. Information generated through use of such a communications framework can provide for improvements to applications, a framework environment, training, etc. As explained, one or more machine learning techniques may be applied to enhance features of a communications framework.

Where a user has to write emails to concerned parties, context of a discussion may be limited due to data confidentiality data. As such, context may not be known until a meeting actually commences. Further, using emails, it may be difficult for users to view past discussions as there may not be a centralized place to view discussions related to a particular client facility. A communications framework can provide for improved security, confidentiality, informing of context, centralization, etc. As explained, in a process operations environment, a communications framework can provide users with a centralized place to view and create discussions. For example, users can tag concerned others and attach images or files to give more context to discussions. Automatic system notifications can be provided to alert users, which can reduce monitoring demands for existing or new discussions.

As an example, a communications framework can be operatively coupled to one or more planning and/or scheduling applications, databases, etc. For example, consider a scheduling application that can provide detailed schedule information for a user, users, etc., optionally along with one or more scheduled activities of a user or users. In such an example, a context may include scheduled activities such that a SME may be able to determine when a recommendation action (e.g., control action, etc.) can occur or may be best to occur. In such an approach, an SME may recommend consolidating the action with one or more other actions. For example, if an action involves going to an offshore facility, the action may be scheduled with one or more other actions to conserve time, acquire results from the other actions, etc. As an example, a communications framework may be integrated with a calendar application for setting up meetings, issuing notifications, etc.

As an example, an API or APIs may provide for seamless integration of web-sessions within a framework of a process operations environment. As explained, one or more MS TEAMS and/or other APIs may be utilized to allow a user to setup audio and/or video meeting invites directly in an application.

As explained, a communications framework may provide for utilization of one or more “reality” technologies such as, for example, virtual and/or augmented reality headsets, smart glasses, etc., which may be utilized to collaborate with on field service workers with SMEs for troubleshooting activities on real-time.

As mentioned, one or more machine learning techniques may be utilized to enhance process operations, a process operations environment, a communications framework, etc. As explained, various types of information can be generated via operations of a communications framework where such information may be utilized for training one or more types of machine learning models to generate one or more trained machine learning models, which may be deployed within one or more frameworks, environments, etc.

As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange to various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, image classification, object detection, pose estimation, question answering, text classification, etc., on multiple platforms.

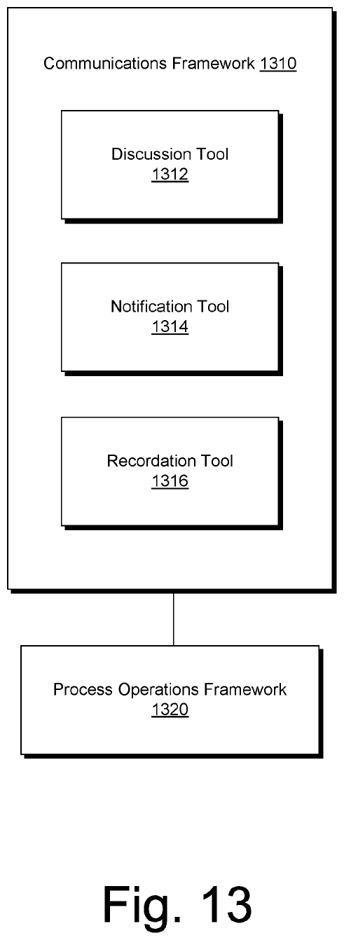

FIG. 13 shows an example of a communications framework 1310 that can include a discussion tool 1312 operable within a process operations environment, where the discussion tool issues a request for communication with an expert and records and/or associates contextual information of the process operations environment; a notification tool 1314 that, responsive to issuance of the request for communication, calls for issuance of a notification to an identified expert; and a recordation tool 1316 that calls for storage of communication information associated with communication with the identified expert to a database. As an example, the communications framework 1310 may be operable in the system 100 of FIG. 1 (e.g., the workspace framework 110, etc.), the system 500 of FIG. 5, the system 600 of FIG. 6, the system 700 of FIG. 7, etc. For example, the communications framework 1310 can be operatively coupled to one or more applications (e.g., frameworks) in the system 600 of FIG. 6 where each of the GUIs 610, 620, 630 and 640 can include the control graphic 605 as part of the communications framework 1310, calling for action by the communications framework 1310, etc. As explained, the GUIs 610, 620, 630 and 640 can be part of a process operations environment, which may be for one or more types of process operations, at one or more levels of a hierarchy of process operations, etc. While an oil and gas industry example is shown in FIG. 6, a communications framework may be utilized in one or more other types of process operations environment where various frameworks (e.g., applications, etc.) provide for monitoring, assessment, control, etc.

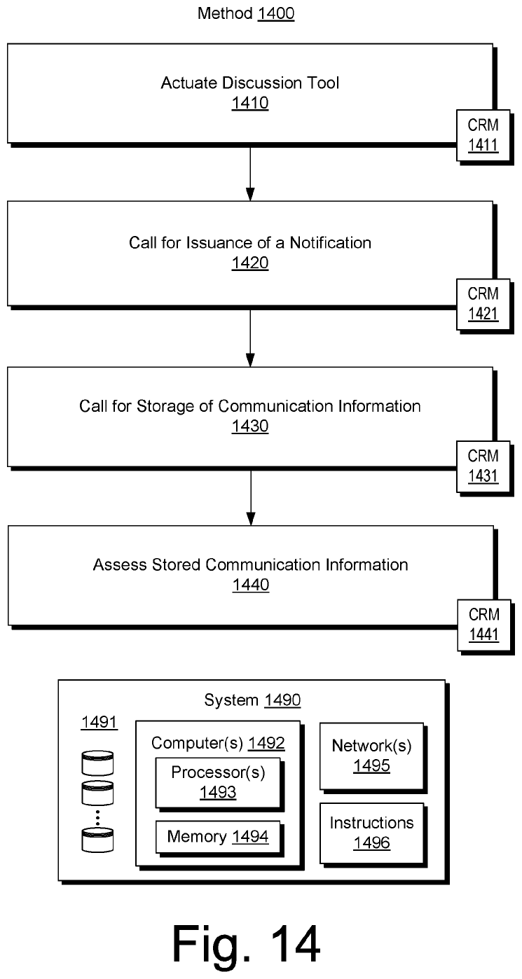

FIG. 14 shows an example of a method 1400 that includes an actuation block 1410 for, within an application of a process operations environment, actuating a discussion tool that issues a request for communication with an expert and records contextual information of the application; a call block 1420 for, responsive to issuance of the request for communication, calling for issuance of a notification to an identified expert; and a call block 1430 for calling for storage of communication information associated with communication with the identified expert to a database. Such a method can also include, for example, assessment block 1440 for assessing stored communication information for one or more purposes.

In the example of FIG. 14, a system 1490 includes one or more information storage devices 1491, one or more computers 1492, one or more networks 1495 and instructions 1496. As to the one or more computers 1492, each computer may include one or more processors (e.g., or processing cores) 1493 and memory 1494 for storing the instructions 1496, for example, executable by at least one of the one or more processors. As an example, a computer may include one or more network interfaces (e.g., wired or wireless), one or more graphics cards, a display interface (e.g., wired or wireless), etc.

The method 1400 is shown along with various computer-readable media blocks 1411, 1421, 1431 and 1441 (e.g., CRM blocks). Such blocks may be utilized to perform one or more actions of the method 1400. For example, consider the system 1490 of FIG. 14 and the instructions 1496, which may include instructions of one or more of the CRM blocks 1411, 1421, 1431 and 1441.

As an example, the method 1400 may be implemented in a system such as, for example, the system 100 of FIG. 1 (e.g., the workspace framework 110, etc.), the system 500 of FIG. 5, the system 600 of FIG. 6, the system 700 of FIG. 7, etc. As explained, the computational frameworks (e.g., applications) 121 of FIG. 1 can include associated GUIs, which may be provided with control graphics such as, for example, the control graphic 605 of FIG. 6, etc.

As an example, a communications framework can include a discussion tool operable within a process operations environment, where the discussion tool issues a request for communication with an expert and records contextual information of the process operations environment; a notification tool that, responsive to issuance of the request for communication, calls for issuance of a notification to an identified expert; and a recordation tool that calls for storage of communication information associated with communication with the identified expert to a database. In such an example, the discussion tool can include a control graphic integrated into applications of the process operations environment, can include a search engine for searching the database, can include a contextual information capture component that captures contextual information from an application of the process operations environment (e.g., where the contextual information capture component associates discussion text and the contextual information), etc. As an example, a capture component may include features to perform a screen capture as an image and/or a GUI information capture such that a GUI can be recreated, for example, by an identified expert using a browser application and/or an instance of the application (e.g., framework) that generated the GUI.

As an example, a notification tool can be operatively coupled to an email application and/or a web-session application. For example, consider a notification tool that can cause a server to issue one or more emails, one or more meeting invites, etc., which may include one or more links.

As an example, a notification can include a link to an application within the process operations environment. For example, consider a method where access to the application via the link requires at least one security credential. In such an example, an individual may receive a notification with a link, actuate the link and then access the application using a password, a certificate, etc. Once in the application, the individual may be able to view a discussion, contextual information, etc., which may include confidential information. In such an approach, confidential information can be protected via one or more security protocols for access to the application.

As an example, an identification tool can provide for identifying one or more experts. For example, consider an identification tool that utilizes contextual information to identify an expert or experts. As an example, an identification tool may access a trained machine learning model where the trained machine learning model utilizes contextual information and/or other information to identify one or more experts. In such an example, identification may consider availability, location, prior interactions (e.g., with a requester, a client, a facility, etc.).

As an example, a recordation tool can store a communication time for a communication with an identified expert. For example, where a discussion via text, a voice call, a web-session, etc., occurs, a communication time may be tracked such that it can be stored for one or more purposes (e.g., invoicing, training, scheduling, resource management, etc.).

As an example, a method can include, within an application of a process operations environment, actuating a discussion tool that issues a request for communication with an expert and records contextual information of the application; responsive to issuance of the request for communication, calling for issuance of a notification to an identified expert; and calling for storage of communication information associated with communication with the identified expert to a database. In such an example, the method can include associating discussion text and the contextual information. As an example, a notification can include a link where, for example, the link is a web-session link and/or a link to an application within a process operations environment, where access to the application via the link requires at least one security credential.

As an example, a method can include identifying an expert based at least in part on a portion of contextual information. As explained, a method can include accessing one or more types of contextual information, which may be associated with one or more graphical user interfaces of an application in a process operations environment (e.g., consider mark-up language, data, plots, client information, facility information, etc.).

As an example, one or more computer-readable media can include computer-executable instructions executable by a system to instruct the system to: within an application of a process operations environment, actuate a discussion tool that issues a request for communication with an expert and records contextual information of the application; responsive to issuance of the request for communication, call for issuance of a notification to an identified expert; and call for storage of communication information associated with communication with the identified expert to a database.

As an example, a computer program product can include one or more computer-readable storage media that can include processor-executable instructions to instruct a computing system to perform one or more methods and/or one or more portions of a method.

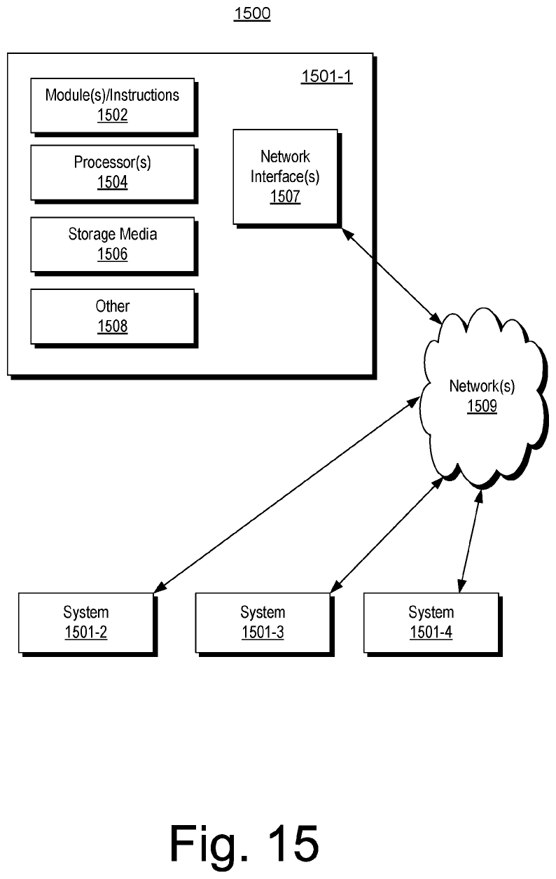

In some embodiments, a method or methods may be executed by a computing system. FIG. 15 shows an example of a system 1500 that can include one or more computing systems 1501-1, 1501-2, 1501-3 and 1501-4, which may be operatively coupled via one or more networks 1509, which may include wired and/or wireless networks.

As an example, a system can include an individual computer system or an arrangement of distributed computer systems. In the example of FIG. 15, the computer system 1501-1 can include one or more modules 1502, which may be or include processor-executable instructions, for example, executable to perform various tasks (e.g., receiving information, requesting information, processing information, simulation, outputting information, etc.).

As an example, a module may be executed independently, or in coordination with, one or more processors 1504, which is (or are) operatively coupled to one or more storage media 1506 (e.g., via wire, wirelessly, etc.). As an example, one or more of the one or more processors 1504 can be operatively coupled to at least one of one or more network interface 1507. In such an example, the computer system 1501-1 can transmit and/or receive information, for example, via the one or more networks 1509 (e.g., consider one or more of the Internet, a private network, a cellular network, a satellite network, etc.).

As an example, the computer system 1501-1 may receive from and/or transmit information to one or more other devices, which may be or include, for example, one or more of the computer systems 1501-2, etc. A device may be located in a physical location that differs from that of the computer system 1501-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1506 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

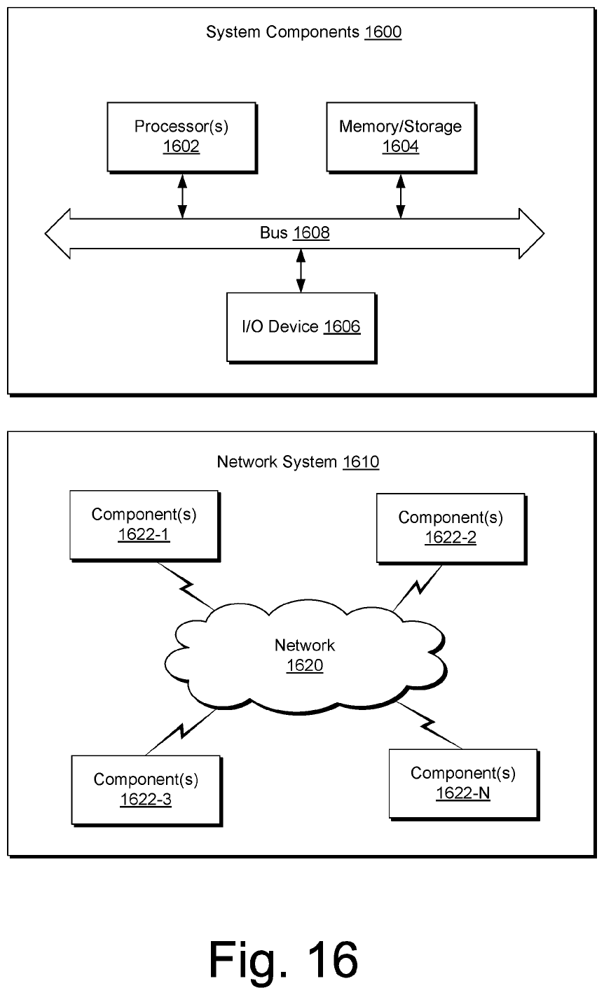

FIG. 16 shows components of an example of a computing system 1600 and an example of a networked system 1610 with a network 1620. The system 1600 includes one or more processors 1602, memory and/or storage components 1604, one or more input and/or output devices 1606 and a bus 1608. In an example embodiment, instructions may be stored in one or more computer-readable media (e.g., memory/storage components 1604). Such instructions may be read by one or more processors (e.g., the processor(s) 1602) via a communication bus (e.g., the bus 1608), which may be wired or wireless. The one or more processors may execute such instructions to implement (wholly or in part) one or more attributes (e.g., as part of a method). A user may view output from and interact with a process via an I/O device (e.g., the device 1606). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1610. The network system 1610 includes components 1622-1, 1622-2, 1622-3, . . . 1622-N. For example, the components 1622-1 may include the processor(s) 1602 while the component(s) 1622-3 may include memory accessible by the processor(s) 1602. Further, the component(s) 1622-2 may include an I/O device for display and optionally interaction with a method. A network 1620 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A communications framework comprising:
a discussion tool operable within a process operations environment, wherein the discussion tool issues a request for communication with an expert and records contextual information of the process operations environment;
a notification tool that, responsive to issuance of the request for communication, calls for issuance of a notification to an identified expert; and
a recordation tool that calls for storage of communication information associated with communication with the identified expert to a database.

2. The communications framework of claim 1, wherein the discussion tool comprises a control graphic integrated into applications of the process operations environment.

3. The communications framework of claim 1, wherein the discussion tool comprises a search engine for searching the database.

4. The communications framework of claim 1, wherein the discussions tool comprises a contextual information capture component that captures contextual information from an application of the process operations environment.

5. The communications framework of claim 4, wherein the contextual information capture component associates discussion text and the contextual information.

6. The communications framework of claim 1, wherein the notification tool is operatively coupled to an email application.

7. The communications framework of claim 1, wherein the notification tool is operatively coupled to a web-session application.

8. The communications framework of claim 1, wherein the notification comprises a link to an application within the process operations environment.

9. The communications framework of claim 8, wherein access to the application via the link requires at least one security credential.

10. The communications framework of claim 1, comprising an identification tool that identifies the identified expert.

11. The communications framework of claim 10, wherein the identification tool utilizes the contextual information.

12. The communications framework of claim 10, wherein the identification tool accesses a trained machine learning model.

13. The communications framework of claim 1, wherein the recordation tool stores a communication time for the communication with the identified expert.

14. A method comprising:
within an application of a process operations environment, actuating a discussion tool that issues a request for communication with an expert and records contextual information of the application;
responsive to issuance of the request for communication, calling for issuance of a notification to an identified expert; and
calling for storage of communication information associated with communication with the identified expert to a database.

15. The method of claim 14, comprising associating discussion text and the contextual information.

16. The method of claim 14, wherein the notification comprises a link.

17. The method of claim 16, wherein the link comprises a web-session link.

18. The method of claim 16, wherein the link comprises a link to the application within the process operations environment, wherein access to the application via the link requires at least one security credential.

19. The method of claim 14, comprising identifying the identified expert based at least in part on a portion of the contextual information.

20. One or more computer-readable media comprising computer-executable instructions executable by a system to instruct the system to:
within an application of a process operations environment, actuate a discussion tool that issues a request for communication with an expert and records contextual information of the application;
responsive to issuance of the request for communication, call for issuance of a notification to an identified expert; and
call for storage of communication information associated with communication with the identified expert to a database.
